(19) United States
(12) Patent Application Publication
(10) Pub. No.: US 2006/0112687 A1
(43) Pub. Date: Jun. 1, 2006

(54) Stirling engine assembly

(76) Inventors: David Anthony Clark, Hugglescote (GB); James Edward Cooper, Leicestershire (GB); Stephen Michael Hasko, Cambridgeshire (GB); Christopher John Spenceley, Yattendon (GB)

Correspondence Address: NEEDLE & ROSENBERG, P.C., SUITE 1000, 999 PEACHTREE STREET, ATLANTA, GA, 30309-3915, US

(21) Appl. No.: 10/542,186

(22) PCT Filed: Jan. 23, 2004
(86) PCT No.: PCT/GB04/00299

§ 371 Date: Jul. 14, 2005

(30) Foreign Application Priority Data
Jan. 24, 2003 (GB) 0301718.3

(51) Int. Cl. F01B 29/10; F02G 1/04

(52) U.S. Cl. 60/520

(57) ABSTRACT

A Stirling engine assembly (1) comprising a Stirling engine (4) having a head (8). A burner (7) surrounds the head and comprises a burner element on which a flame is sustained. The burner is fed with a combustible gas stream. A recuperator (20) preheats the gas stream with combustion products from the burner. A coolant circuit (32) is positioned to absorb heat, which is radiated from the back of the burner element away from the head, into a coolant stream separate from the gas stream.

The present invention relates to a Stirling engine assembly.

Stirling engine assemblies are known in the art, for example, WO 99/40309 having a recuperator at the Stirling engine head to heat the air supplied to the burner with combustion gases from the burner. The exterior surface of the recuperator is exposed to the air within the interior of an appliance and hence any heat dissipated from the surface of the recuperator is dissipated into the appliance.

The principal purpose of the burner/recuperator assembly is to maintain the temperature of the engine head with the minimum amount of energy. This minimisation of energy is achieved with the use of the recuperator which recovers heat from the burner exhaust gas and uses it to preheat air/gas mixture supplied to the burner. The degree of recuperation and thermal efficiency can be maintained with the use of insulation around the outside of the appliance. However, two factors must be taken into consideration.

Firstly, the temperature of the incoming air/gas mixture must remain below a critical upper limit. If this limit is exceeded, auto-ignition of the mixture can occur resulting in further over heating and potential damage to the appliance.

Secondly, the appliance may house thermally sensitive electrical components which have a nominal maximum temperature. Therefore, the amount of heat dissipated from the burner/recuperator assembly must be maintained at a level to prevent any damage to the electrical components.

According to the present invention the Stirling engine assembly comprises a Stirling engine having a head; a burner surrounding the head and comprising a burner element on which a flame is sustained, the burner being fed with a combustible gas stream; a recuperator to preheat the gas stream with combustion products from the burner; and a coolant circuit positioned to absorb heat, which is radiated from the back of the burner element away from the head, into a coolant stream separate from the gas stream.

The present invention uses a burner which surrounds the Stirling engine head to provide particularly effective heat transfer to the head. However, a significant amount of heat radiates away from the burner element which, in turn, can radiate to the recuperator walls and subsequently into the appliance. By removing some of this heat into a separate coolant stream, the temperature of both the incoming gas and the interior of the appliance can be controlled.

The coolant stream for the burner element may be a dedicated stream. However, preferably, the coolant stream is a stream which has cooled the cool end of the Stirling engine. Such a stream is conveniently available and therefore has cost and space benefits.

Preferably, the coolant stream is arranged to subsequently receive heat from the exhaust gas from the burner. In domestic combined heat and power applications, the coolant stream which is heated in this way can be used to supply a domestic heating requirement such as the central heating or water heating. With such an arrangement, a supplementary burner is preferably also provided to supply further heat to the coolant stream to ensure that the domestic heat demand can be met at all times.

A flexible seal may be provided between the burner and the Stirling engine head in order to prevent the escape of gases from the burner into the appliance. In this case, the seal may also be cooled by the coolant stream which is used to cool the burner element. The cooled flexible seal arrangement is the subject of a separate co-pending application GB 0211121.9. The burner element and seal may be positioned such that a common duct for the coolant stream can cool both the burner element and seal on a single pass around the head.

An example of a burner assembly in accordance with the present invention will now be described with reference to the accompanying drawings, in which:

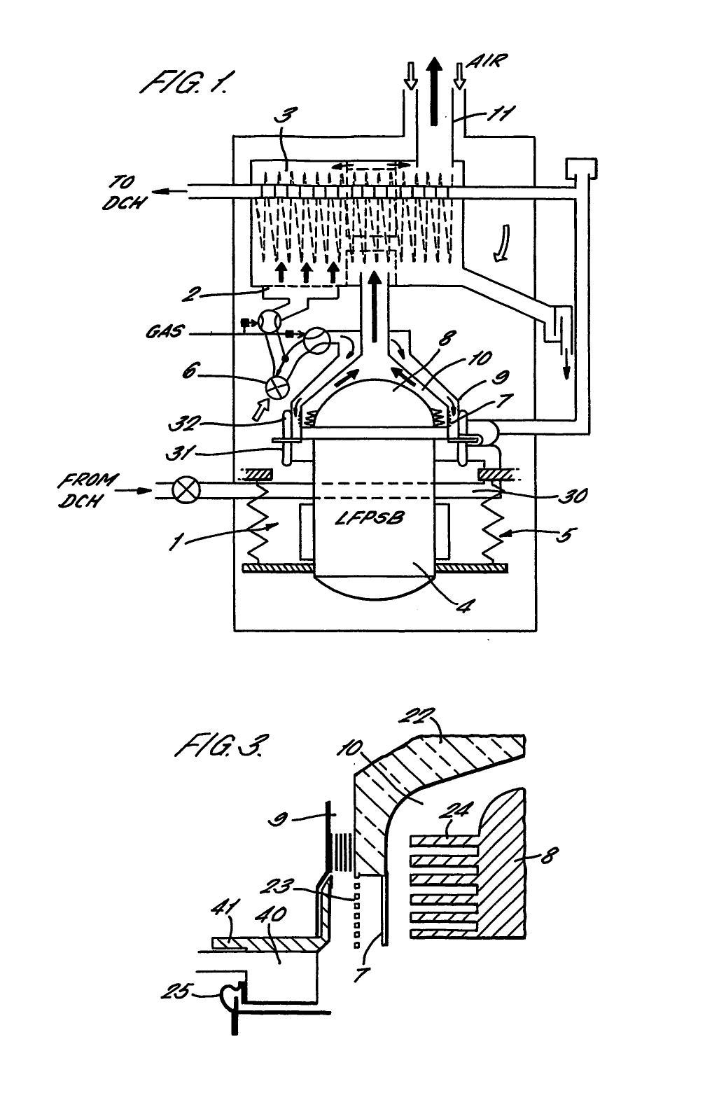

FIG. 1 is a schematic representation of a combined heat and power system incorporating a Stirling engine assembly of the present invention;

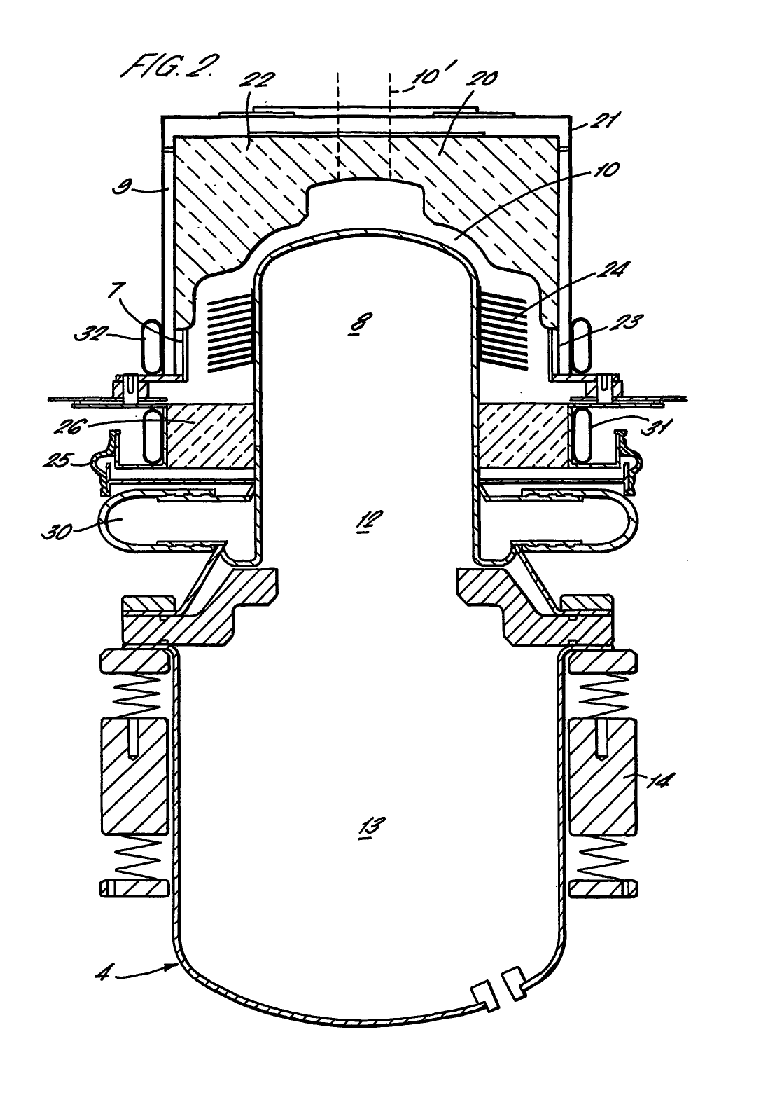

FIG. 2 is a cross-section through a Stirling engine assembly of the present invention; and

FIG. 3 shows, in cross-section, part of a Stirling engine assembly according to the present invention with a modified cooling arrangement.

The domestic combined heat and power system shown in FIG. 1 comprises a Stirling engine assembly 1 together with a supplementary burner 2 and a heat exchanger 3 in which water from a domestic central heating or hot water system is heated by exhaust gas from the Stirling engine assembly and by the supplementary burner.

The Stirling engine assembly 1 comprises a Stirling engine 4 supported on a resilient support 5. A fan 6 provides a supply of combustible gas to a burner 7 surrounding the head 8 of the Stirling engine. The gas is supplied along the gas supply duct 9 and combustion gases which have heated the head 8 subsequently flow along exhaust gas duct 10 which is surrounded by the gas supply duct 9. Exhaust gas is subsequently fed to the heat exchanger 3 where it combines with combustion products from the supplementary burner 2 (which is also fed with combustible gases by fan 6). The combined stream is then exhausted through a concentric flue 11.

The nature of the Stirling engine assembly is shown in more detail in FIG. 2.

In addition to the engine head 8, the Stirling engine comprises an engine cooler 12 and an alternator 13. The internal structure of a Stirling engine is well known in the art and will not be described in greater detail here. An annular absorber mass 14 surrounds the Stirling engine 4 and is resiliently mounted thereto to counteract vibrations of the Stirling engine.

A recuperator 20 is positioned above and around the head 8 of the Stirling engine. The recuperator comprises an outer casing 21 in which a block of insulation 22 is mounted. The gas supply duct 9 is defined between the casing 21 and insulation 22, while the bottom surface of the block of insulation 22 is profiled to define the exhaust gas duct 10 between itself and the Stirling engine head 8. This extends out through top of the casing 21 as shown at 10′ in FIG. 2, although this duct is out of the plane of the cross-section of FIG. 2.

The burner 7 has a flame distribution strip 23 which distributes the gas more evenly to the annular burner 7. The majority of the heat from the burner 7 is transmitted by forced convection and radiation to the heater head 8, with the absorption being aided by a system of annular fins 24. Some heat is radiated into the recuperator or radially outwardly of the burner as described in greater detail below.

The Stirling engine 4 will vibrate to a limited degree with respect to the burner 7 and recuperator 20. A flexible seal 25 is therefore provided between the Stirling engine 4 and the burner housing. As shown in FIG. 2, this seal is positioned away from the burner 7 and separated from the burner by a block of insulation 26 in order to limit the temperature that the seal 25 has to withstand.

The cooling arrangement for the Stirling engine is as follows. Cool water which, in a domestic combined heat and power system, has given up its heat to satisfy the domestic heat requirement is initially passed around engine cooler 30 to maintain the cold end 12 of the Stirling engine at the lowest possible temperature. The water is then fed around a seal cooler path 31 surrounding the insulation 26 to absorb heat at this point thereby limiting further the temperature that the seal 25 has to withstand.

The water is then fed to an annular burner cooler path 32 surrounding the burner 7 which absorbs the heat which is radiated outwardly from the flame distribution strip 23. As shown in FIG. 1, the water is then fed to heat exchanger 3 where it is further heated by the exhaust gas from the Stirling engine and by the supplementary burner 2 as described above.

Although the various water paths have been described above as being in series, it is possible for certain of the paths to be arranged in parallel. In particular, the seal cooler path 31 and burner cooler path 32 may be in parallel, with manually adjusted flow control valves located in the parallel flow paths, to enable the flows to be balanced.

As the burner cooler path 32 extracts heat from the burner, the effect of using this is that, in order to maintain the nominal head operating temperature of approximately 550□C, more heat is required from the burner. However, this is offset by an increase in thermal efficiency due to the recovery of heat from the burner that would otherwise have been dissipated into the appliance.

An alternative configuration for cooling the recuperator is shown in FIG. 3. This figure shows only a top left hand portion of the Stirling engine assembly as the remainder of the engine is as shown in FIG. 2.

In the example of FIG. 3, the seal cooler path 31 and burner cooler path 32 have been replaced by a single cooling channel 40. A thermal bridge 41, which is an annular disk of material of high thermal conductivity, provides a heat path from the burner 7 to the cooling channel 40, while the seal 25 is positioned adjacent to the cooling channel 40. This allows the integration of the cooling arrangement for the burner 7 and seal 25 into a single assembly thereby reducing manufacturing costs and materials.

1. A Stirling engine assembly comprising a Stirling engine having a head; a burner surrounding the head and comprising a burner element on which a flame is sustained, the burner being fed with a combustible gas stream; a recuperator to preheat the gas stream with combustion products from the burner; and a coolant circuit positioned to absorb heat, which is radiated from the back of the burner element away from the head, into a coolant stream separate from the gas stream.

2. An assembly according to claim 1, wherein the coolant stream is configured to pass around a cool end of the Stirling engine prior to passing around the burner element.

3. An assembly according to claim 1, wherein the coolant stream is configured to receive heat from the exhaust gas from the burner after it has passed around the burner element.

4. An assembly according to claim 3, wherein the coolant stream is configured to receive heat from a supplementary burner after it has passed around the burner element.

5. An assembly according to claim 1, wherein a flexible seal is provided between the burner and the Stirling engine head in order to prevent the escape of gases from the burner, and the coolant stream is configured to cool the flexible seal.

6. An assembly according to claim 5, wherein the coolant stream is configured such that a common duct cools both the burner element and seal on a single pass around the head.
